(19) United States
(12) Patent Application Publication
(10) Pub. No.: US 2009/0248557 A1
(43) Pub. Date: Oct. 1, 2009

(54) METHOD FOR AGGREGATING AND ANALYZING CONSUMER BUSINESS DATA

(76) Inventors: Michael Reed, San Diego, CA (US); Frank Roderic Vandervort, Ramona, CA (US); Carol Thomas, Ramona, CA (US)

Correspondence Address: JAMES M. STOVER;TERADATA CORPORATION, 2835 MIAMI VILLAGE DRIVE, MIAMISBURG, OH, 45342, US

(21) Appl. No.: 12/055,363

(22) Filed: Mar. 26, 2008

(51) Int. Cl. G06Q 40/00

(52) U.S. Cl. 705/35

(57) ABSTRACT

A method and system of aggregating consumer business data such as transactions between a consumer and a pluralityy of vendors. The method includes receiving a request from a consumer to maintain consumer business data in a data warehouse. An electronic receipt is received from a vendor following conclusion of a transaction between the consumer and the vendor. A report is generated at the request of the consumer. The report is provided to the consumer.

### BACKGROUND

A major problem for an individual consumer is understanding where, when and how they spend their money. This problem is aggregated by the fact that a person can pay for things using different forms. These forms include checks from many different accounts, credit and debit cards from the different vendors, and Internet-based methods such as from providers such as Paypal and Google.

With all of these different payment methods, it is next to impossible for a consumer to obtain a comprehensive view of his or her spending patterns. The data is stored in many different forms and not readily available to the individual.

There are some solutions that attempt to help consumers track and manage their spending. Examples include software applications such as Quicken and Microsoft Money. The drawback of these applications is that the burden of data collection and management is placed upon an individual user. These applications do offer download options to pull information from some financial institutions and retailers, but the data must be actively managed by the consumer. For these reasons, the data is often not complete, up to date, nor accurate. Such software packages usually store summary data from transactions and do not store itemized receipt information.

Financial institutions and credit card companies also provide partial solutions to help manage this problem. Typically, these companies are only interested in aggregating and presenting data for the items purchased from their business, or items purchased using their credit card. None of these companies provide a comprehensive view of a consumer's spending.

### SUMMARY

Described below is a method of aggregating consumer business data such as transactions between a consumer and a plurality of vendors. The method includes receiving a request from a consumer to maintain consumer business data in a data warehouse. An electronic receipt is received from a vendor following conclusion of a transaction between the consumer and the vendor. A report is generated at the request of the consumer. The report is provided to the consumer.

Also described below is a consumer business data aggregation system. The system includes a storage provider configured to receive a request from a consumer to maintain consumer business data in a data warehouse. The consumer business data comprises transactions between a consumer and a plurality of vendors. The storage provider is configured to receive electronic receipts from vendors following conclusion of respective transactions between consumers and vendors. An analysis module is configured to analyze the consumer business data in the data warehouse. A report module is configured to generate a report from the analyzed data at the request of the consumer and to provide the report to the consumer.

### BRIEF DESCRIPTION OF THE DRAWINGS

FIG. 1 shows a system suitable to aggregating and analyzing consumer business data

FIG. 2 shows a sample user interface for managing user identities.

FIG. 3 shows a sample printed receipt sent from a vendor to a user.

FIG. 4 shows a sample electronic receipt sent from a vendor to a storage provider.

FIG. 5 shows a sample set of data generated from the electronic receipt of FIG. 4.

FIG. 6 shows one example report generated by the report module of FIG. 1 for a user.

FIG. 7 shows a further example report generated by the report module of FIG. 1 for a user.

FIG. 8 is a block diagram of an exemplary large computer system in which the techniques described below are alternatively implemented.

### DETAILED DESCRIPTION

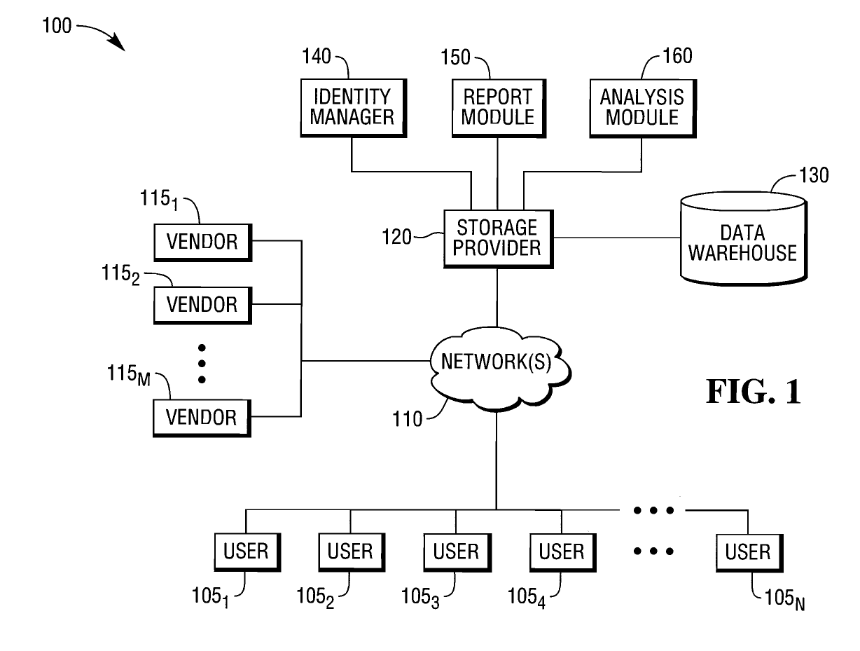

FIG. 1 shows an example system 100 suitable for aggregating and analyzing consumer business data. The consumer business data comprises transactions between a consumer and a plurality of vendors. System 100 includes a plurality of users 105_{1 . . . n}. Each user operates a network computing device that is interfaced to one or more data networks 110. Users conduct financial transactions with one or more vendors 115_{1 . . . m}. Payment for transactions can be made at point of sale, by mail order or secure internet payment. Payment methods include cash, check, debit card, credit card and stored value card.

The techniques described below provide benefits to a user 105. The techniques provide a method and system for aggregating and analyzing data obtained from financial transactions between users 105 and vendors 115.

The system 100 includes a storage provider 120. The storage provider 120 has access to a data warehouse 130, an identity manager 140, a report module 150 and an analysis module 160. These components are described below.

Users 105 individually subscribe to a service provided by storage provider 120. The user transmits a request to the storage provider 120 over the networks 110. The request is for the storage provider 120 to maintain consumer business data in a data warehouse. It is also envisaged that alternative means of communication are available such as email, facsimile, web form, and postal mail.

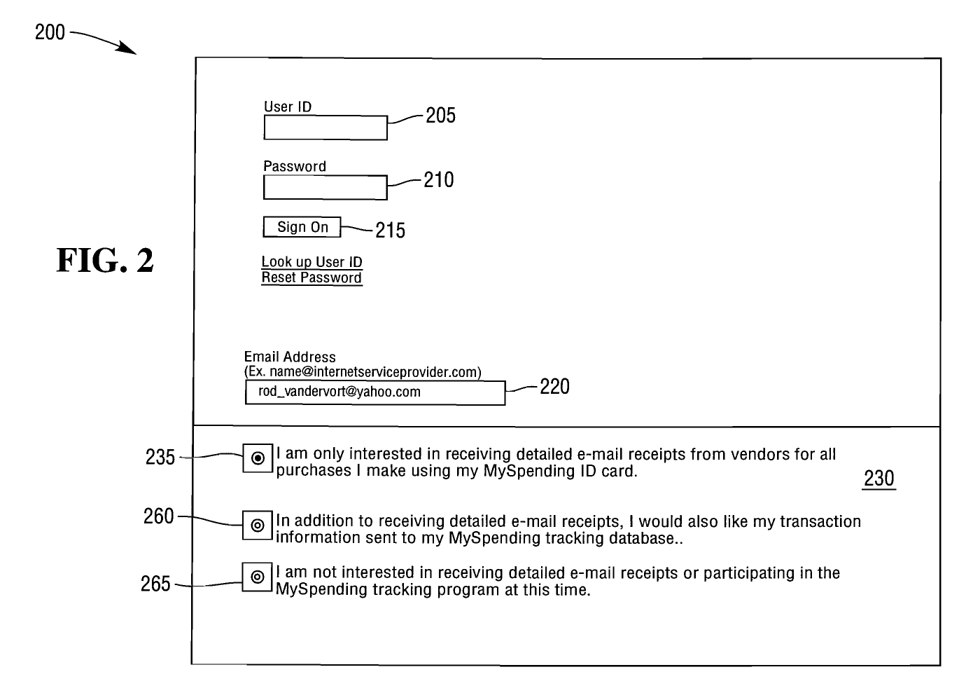

Referring to FIG. 2, it is envisaged that identity manager 140 provides a user interface 200 to a user 105. The user interface 200 accepts from a user a user ID 205 and password 210. It is envisaged that each user has a unique account number similar to a social security identifier or a system supplied account number.

The user enters data in the user identifier and password and then signs on using sign on button 215.

The user optionally enters further data such as email address 220. It is also envisaged that the user interface 200 in one or more preferred forms provides options to a user as set out in 230. These options include a first option 235 that the user is only interested in receiving detailed email receipts from vendors for all purchases made by the user using a particular identifier card.

A second option 240 requests transaction information to be sent to storage provider 120, as well as the user receiving email receipts.

A third option 245 states that the user is not interested in receiving detailed email receipts or participating in the tracking system described below.

When a user 105 makes a purchase from a vendor 115, the vendor sends a detailed electronic receipt via email to the user 105. The email address to which the detailed electronic receipt is sent is based upon the user's receipt preference defined by the customer loyalty or credit card used.

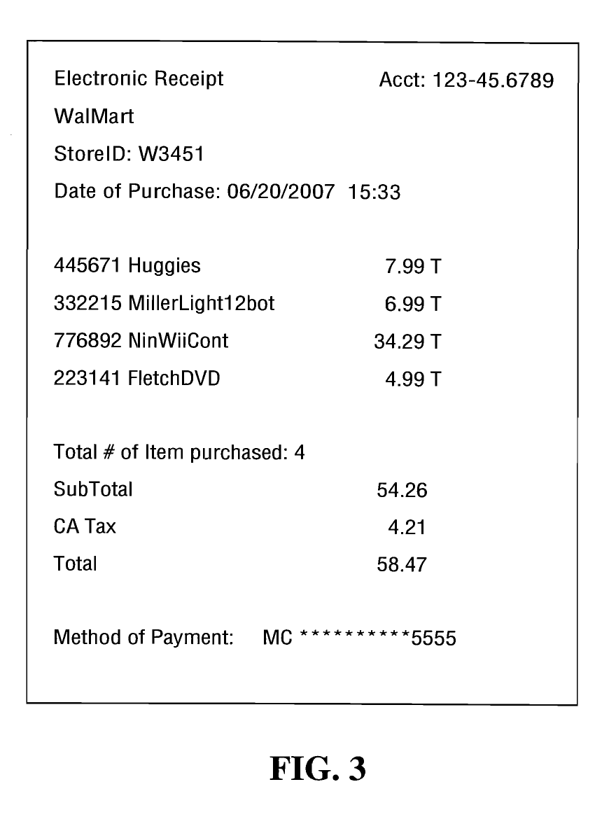

FIG. 3 shows a sample printed receipt sent from the vendor 115 to a user 105. The receipt includes an itemized list of items purchased, date of purchase, time of purchase, dollar amount, payment method. The receipt further includes vendor name, information and classification.

If the user 105 has requested that transaction data be sent from the vendor 115 to the storage provider 120, the vendor sends this transaction information in the form of an electronic receipt by network 110 to storage provider 120.

It is envisaged that the electronic receipt sent from the vendor to the storage provider 120 is sent using a defined XML business to business communication message. The format is equivalent to those already used for inter-business transaction communications. The business to business transaction contains an itemized list of items purchased, date of purchase, time of purchase, dollar amount, and payment method. The transaction date further includes vendor name, vendor information and vendor classification. An example of vendor classification is airline travel, restaurant or electronics retailer. This data is stored in near real time in the data warehouse 130 by the storage provider 120.

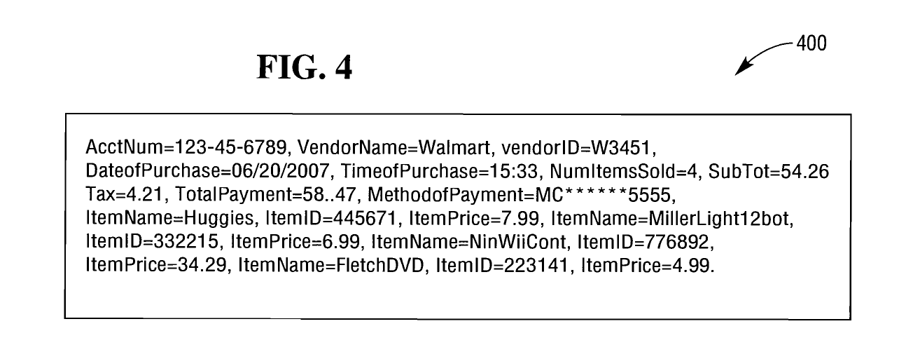

FIG. 4 shows an example electronic receipt 400 sent from a vendor 115 to the storage provider 120. In this particular transaction, the user has purchased four items and details of these items are set out in the electronic receipt.

Consumer business data including consumer business data obtained from individual electronic receipts are stored in the data warehouse 130. An example database schema for storing this information includes five different tables. These tables are a customer information table, a vendor table, a receipt summary table, a product code table, and a receipt detail table.

An example Cust_info table is created using a create table command in SQL. An example command is set out below.

| CREATE TABLE Cust_info ( | |
|---|---|
| CustomerID | varchar(20), |
| Customer Name | varchar(60), |
| LogonID | varchar(30), |
| Password | varchar(20), |
| TrackingStatus | integer |
| ); | |

An example vendor table is created using the following create table SQL command.

| | |
|---|---|
| CREATE TABLE Vendor ( | |
| VendorID | varchar(20), |
| VendorName | varchar(60), |
| ); | |

Also set out below are sample SQL statements for creating a receipt summary table, a product code table, and a receipt detail table respectively.

| CREATE TABLE ReceiptSummary ( | |
|---|---|
| CustomerID | varchar(20), |
| VendorID | varchar(20), |
| NumofItems | int, |
| Date | timestamp, |
| ItemClassification | varchar(40), |
| Amount | decimal(10.2), |
| ReceiptID | varchar(20) |
| ); | |

| CREATE TABLE ProductCode ( | |
|---|---|
| VendorID | varchar(20), |
| ItemID | varchar(20), |
| ItemName | varchar(60), |
| ); | |

| CREATE TABLE ReceiptDetail ( | |
|---|---|
| CustomerID | varchar(20), |
| ReceiptID | varchar(20), |
| ItemName | varchar(60), |
| ItemCode | varchar(20), |
| ItemPrice | decimal(10.2) |
| ); | |

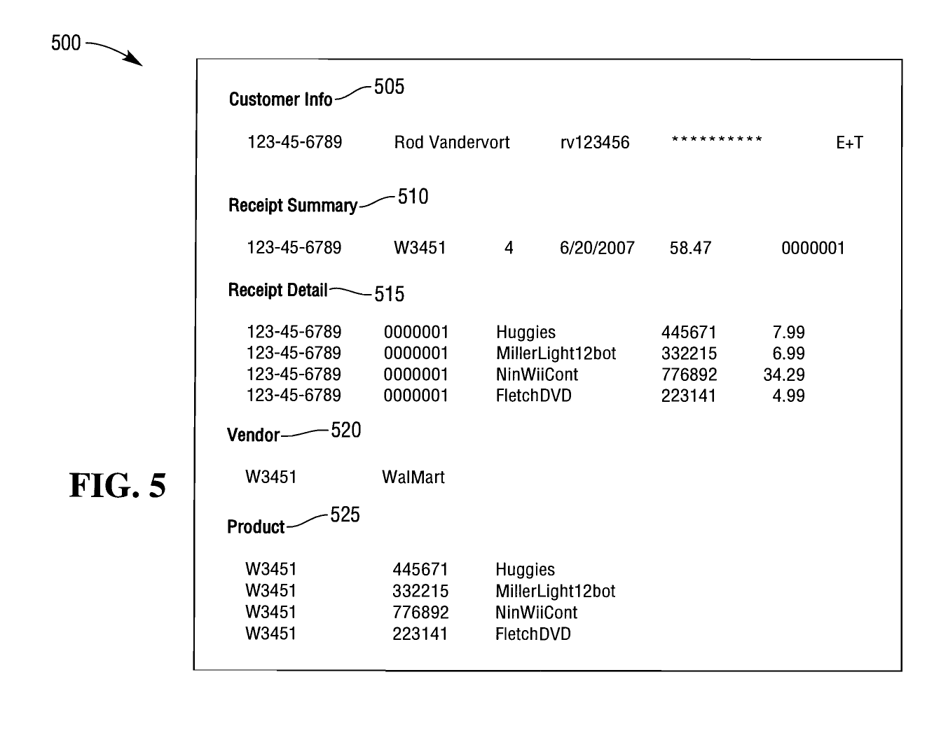

FIG. 5 shows a sample set of table data generated from the electronic receipt of FIG. 4. The tables 500 include customer info table 505, a receipt summary table 510, a receipt detail table 515, a vendor table 520 and a product table 525.

Once the data is stored in data warehouse 130, the user is able to request reports and analysis of spending patterns. The report module 150 is configured to generate a set of “canned” reports for typical analysis. These canned reports are predefined queries. The user is able to select one of these predefined queries. These canned reports include a spending breakdown by month, by vendor classification, by item category, by items over a threshold dollar amount and so on. In one form the analysis module is configured to accept more sophisticated tailored queries from the user. In one embodiment the report module and analysis module are maintained as a single report module.

These reports are provided to the consumer in a manner specific to the user's preferences. These reports are provided in electronic form and/or hard copy for example.

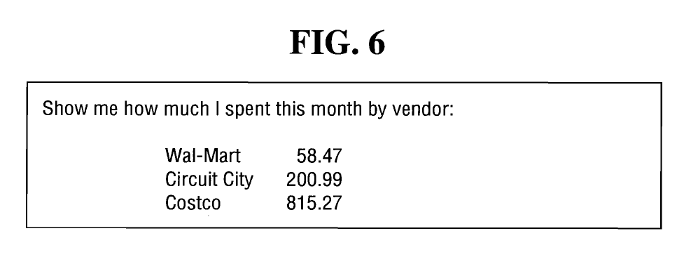

FIG. 6 shows an example report generated by the report module 150 for the user 105. The report shows how much the user spent in any given month. The report is grouped by vendor.

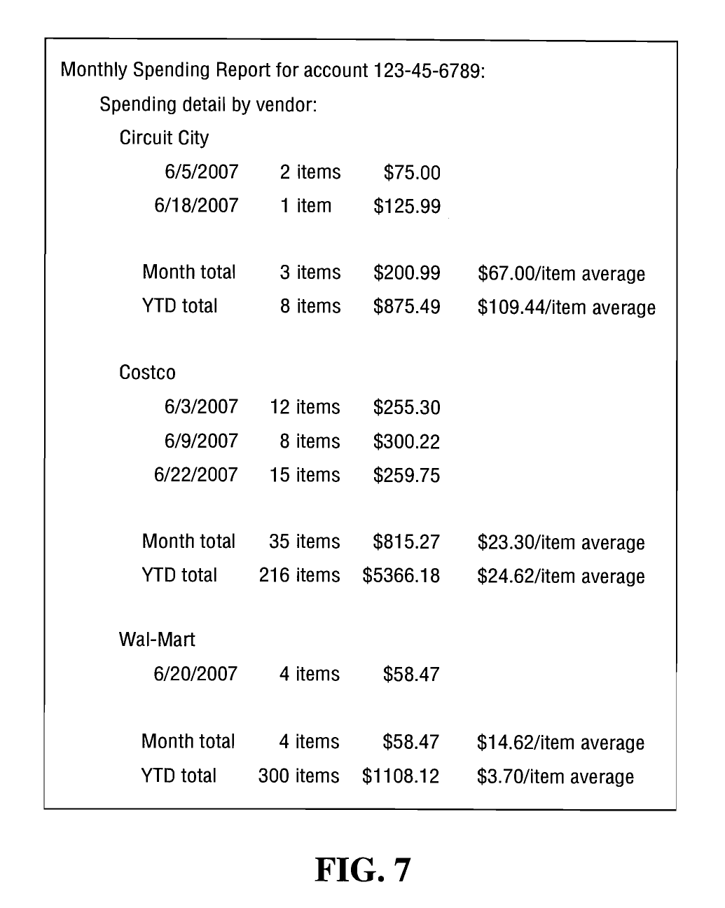

FIG. 7 shows a further example report that breaks down consumer spending in a month by vendor.

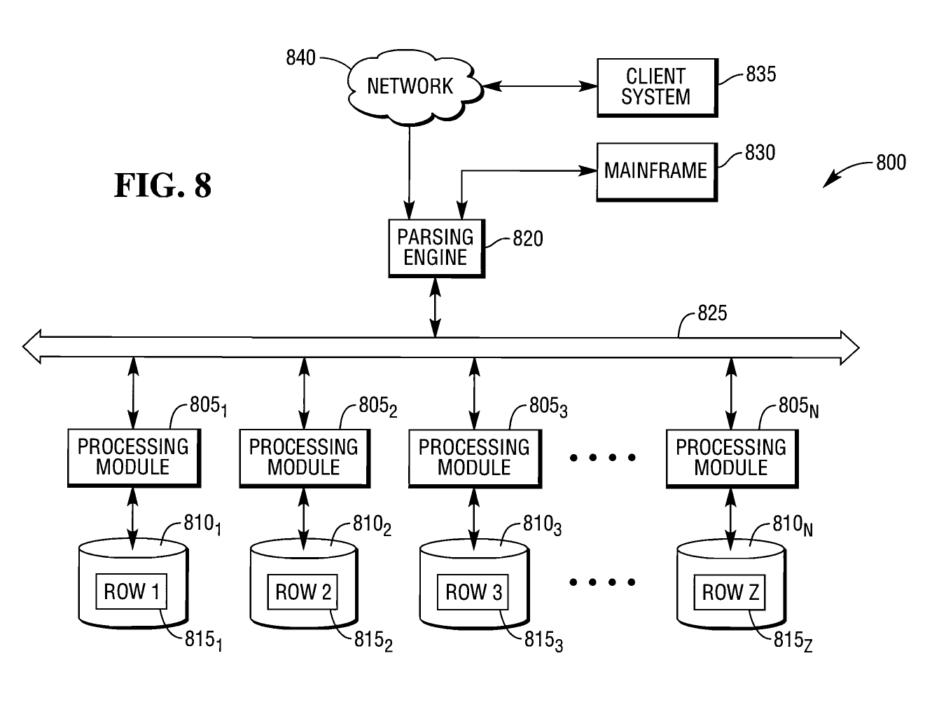

FIG. 8 shows an example of a database system 800, such as a Teradata Active Data Warehousing System available from Teradata Corporation, in which the above techniques are implemented. In computer system 800, vast amounts of data are stored on many disk-storage facilities that are managed by many processing units. In this example, the data warehouse 800 includes a relational database management system (RDMS) built upon a massively parallel processing (MPP) platform.

Other types of database systems, such as object-relational database management systems (ORDMS) or those built on symmetric multi-processing (SMP) platforms, are also suited for use here.

The data warehouse 800 includes one or more processing modules 805_{1 . . . N} that manage the storage and retrieval of data in data storage facilities 810_{1 . . . N}. Each of the processing modules 805_{1 . . . N} manages a portion of a database that is stored in a corresponding one of the data storage facilities 810_{1 . . . N}. Each of the data storage facilities 810_{1 . . . N} includes one or more disk drives.

The system stores data in one or more tables in the data storage facilities 810_{1 . . . N}. The rows 815_{1 . . . Z} of the tables are stored across multiple data storage facilities 810_{1 . . . N} to ensure that the system workload is distributed evenly across the processing modules 805_{1 . . . N}. A parsing engine 820 organizes the storage of data and the distribution of table rows 815_{1 . . . Z} among the processing modules 805_{1 . . . N}. The parsing engine 820 also coordinates the retrieval of data from the data storage facilities 810_{1 . . . N} over network 825 in response to queries received from a user at a mainframe 830 or a client computer 835 connected to a network 840. The database system 800 usually receives queries and commands to build tables in a standard format, such as SQL.

In one implementation, the rows 815_{1 . . . Z} are distributed across the data-storage facilities 810_{1 . . . N} by the parsing engine 820 in accordance with their primary index. The primary index defines the columns of the rows that are used for calculating a hash value. The function that produces the hash value from the values in the columns specified by a primary index is called a hash function. Some portion, possibly the entirety, of the hash value is designated a “hash bucket”. The hash buckets are mapped to data-storage facilities 810_{1 . . . N} and associated processing modules 805_{1 . . . N} by a hash bucket map (not shown). The characteristics of the columns chosen for the primary index determine how evenly the rows are distributed.

The techniques described above allow a consumer's transactions to be captured. Detailed information is stored in a data warehouse, regardless of the payment method used by the user. The techniques described above use an opt in email receipt option and data warehouse service.

The transaction data is loaded into the data warehouse in near real time. Historical spending information is kept up to date without requiring the consumer to manually enter or pull the data from multiple financial or other institutions.

Detailed receipt data is maintained. There is an ability to produce custom reports/analytics over the data the consumer has access to. Examples of benefits are easy access to purchase date for warranty information, detailed itemized list of item purchased, cost and date for insurance loss recovery, and sales tax tracking for items purchased over the Internet.

Individual consumers are able to choose to sell aggregated information about their spending habits to marketing firms. Here the consumer has a choice to sell or not and gets direct financial benefit from making summary data available.

We claim:

1. A method of aggregating consumer business data, the consumer business data comprising transactions between a consumer and a plurality of vendors, the method comprising:
receiving a request from a consumer to maintain consumer business data in a data warehouse;
receiving an electronic receipt from a vendor following conclusion of a transaction between the consumer and the vendor;
generating a report at the request of the consumer, and
providing the report to the consumer.

2. The method of claim 1 wherein the payment method for the transaction includes one or more of the following: point of sale, mail order, secure internet payment.

3. The method of claim 1 wherein the payment method for the transaction includes one or more of the following: cash, check debit card, credit card, stored value card.

4. The method of claim 3 wherein the electronic receipt includes one or more of the following: item(s) purchased, date of purchase, time of purchase, dollar amount, payment method, vendor name, vendor classification.

5. The method of claim 4 wherein the electronic receipt is received in a defined XML format.

6. The method of claim 1 wherein the method of communication for the request includes one or more of email, facsimile, web form and postal mail.

7. The method of claim 1 wherein the report provides a spending breakdown by month.

8. The method of claim 1 wherein the report provides a spending breakdown by vendor classification.

9. The method of claim 1 wherein the report provides a spending breakdown of items over a threshold dollar amount.

10. A consumer business data aggregation system comprising:
a storage provider configured to receive a request from a consumer to maintain consumer business data in a data warehouse, the consumer business data comprising transactions between a consumer and a plurality of vendors, the storage provider configured to receive electronic receipts from vendors following conclusion of respective transactions between consumers and vendors;
an analysis module configured to analyze the consumer business data in the data warehouse; and
a report module configured to generate a report from the analyzed data at the request of the consumer and to provide the report to the consumer.

11. The system of claim 10 wherein the payment method for the transactions includes one or more of the following: point of sale, mail order, secure internet payment.

12. The system of claim 10 wherein the payment method for the transactions includes one or more of the following: cash, check debit card, credit card, stored value card.

13. The system of claim 12 wherein the electronic receipt includes one or more of the following: item(s) purchased, date of purchase, time of purchase, dollar amount, payment method, vendor name, vendor classification.

14. The system of claim 13 wherein the electronic receipt is received in a defined XML format.

15. The system of claim 10 wherein the method of communication for the request includes one or more of email, facsimile, web form and postal mail.

16. The system of claim 10 wherein the report provides a spending breakdown by month.

17. The system of claim 10 wherein the report provides a spending breakdown by vendor classification.

18. The system of claim 10 wherein the report provides a spending breakdown of items over a threshold dollar amount.

19. Computer readable media on which is stored computer executable instructions that when executed on a computing device cause the computing device to perform a method of aggregating consumer business data, the consumer business data comprising transactions between a consumer and a plurality of vendors, the method comprising:
receiving a request from a consumer to maintain consumer business data in a data warehouse;
receiving an electronic receipt from a vendor following conclusion of a transaction between the consumer and the vendor,
generating a report at the request of the consumer, and
providing the report to the consumer.

20. Computer readable media as claimed in claim 19 wherein the payment method for the transaction includes one or more of the following: point of sale, mail order, secure internet payment.

21. Computer readable media as claimed in claim 19 wherein the payment method for the transaction includes one or more of the following: cash, check, debit card, credit card, stored value card.

22. Computer readable media as claimed in claim 21 wherein the electronic receipt includes one or more of the following: item(s) purchased, date of purchase, time of purchase, dollar amount, payment method, vendor name, vendor classification.

23. Computer readable media as claimed in claim 22 wherein the electronic receipt is received in a defined XML format.

24. Computer readable media as claimed in claim 19 wherein the method of communication for the request includes one or more of email, facsimile, web form and postal mail.

25. Computer readable media as claimed in claim 19 wherein the report provides a spending breakdown by month.

26. Computer readable media as claimed in claim 19 wherein the report provides a spending breakdown by vendor classification.

27. Computer readable media as claimed in claim 19 wherein the report provides a spending breakdown of items over a threshold dollar amount.
